(19) United States
(12) Patent Application Publication
(10) Pub. No.: US 2026/0251599 A1
(43) Pub. Date: Aug. 27, 2026

(54) Automation Component and Method for Analyzing the Material Composition of a Test Object

(71) Applicant: Siemens Aktiengesellschaft, Muenchen (DE)

(72) Inventor: Gunter GRIESSBACH, Gelenau (DE)

(21) Appl. No.: 18/878,193

(22) PCT Filed: May 4, 2023
(86) PCT No.: PCT/EP2023/061784

§ 371 Date: Dec. 23, 2024

(30) Foreign Application Priority Data
Jun. 28, 2022 (EP) 22181453.6

(51) Int. Cl. G01N 27/02; G05B 23/02

(52) U.S. Cl. CPC G01N 27/026; G05B 23/024

(57) ABSTRACT

A method for analyzing the material composition of a test object, wherein an impedance spectrum is picked up from the test object via a sensor via an impedance measurer using an electric test signal, different material compositions are stored in an allocation table, a respective test sample is provided for each material composition, the respective test sample is used for the test object, and a specifiable number of test spectra are picked up from the respective test sample using the impedance measurer, and a specific neural network is trained for the number of test spectra of the respective material compositions in a learning phase, where a currently acquired impedance spectrum of the test object is analyzed using the material compositions of specific neural networks, and the material composition best matching respective material compositions of the specific neural network for the impedance spectrum to be analyzed is output as a result.

### CROSS-REFERENCE TO RELATED APPLICATIONS

This is a U.S. national stage of application No. PCT/EP2023/061784 filed 4 May 2023. Priority is claimed on European Application No. 22181453.6 filed 28 Jun. 2022, the content of which is incorporated herein by reference in its entirety.

### BACKGROUND OF THE INVENTION

### 1. Field of the Invention

The invention relates to a an automation component comprising an impedance measuring unit and a method for analyzing a material composition of a test object, in which the impedance measuring unit uses an electric test signal to acquire an impedance spectrum dependent on a frequency and/or an amplitude of the test signal from the test object via a sensor.

### 2. Description of the Related Art

By measuring impedances of a test object at different frequencies, properties of the test object can be revealed. The measuring procedure is known as impedance spectroscopy.

Suitable measuring devices for impedance measurement are known. These allow impedance measurement at different frequencies. The resulting complex impedance values can then be represented as a curve over the frequency, i.e., as the impedance spectrum. It is usual to determine the impedance spectrum with the help of special sensors that enable different test objects or materials to be examined.

WO 2018/203055 A1 describes a method for determining the conductivity of a material aided by impedance spectroscopy.

EP 0 782 692 B1 shows a special operation of a measuring coil with multiple frequency components simultaneously. In contrast to electric components in which the impedances are mainly described by physical relationships and can be calculated, there are also impedance curves that cannot be readily assigned to physical laws.

### SUMMARY OF THE INVENTION

It is an object of the present invention, in particular for manufacturing automation technology, to provide a method for analyzing the material composition of a test object, i.e., for test objects in which the impedance curves cannot be verified by physical laws, such as by calculating a formula.

This and other objects and advantages are achieved in accordance with the invention by a method for analyzing a material composition of a test object, where an impedance measuring unit uses an electric test signal to acquire an impedance spectrum dependent on a frequency and/or an amplitude of the test signal from the test object via a sensor, where different material compositions are stored in an allocation table, where a test sample is provided for each material composition, where the respective test sample is employed for the test object in a detection phase and a specifiable number of test spectra are acquired from the respective test sample via the impedance measuring unit and the number of test spectra are stored in a sample detection unit as a training data set specific for the material composition, a neural network specific for the material composition is trained for the number of test spectra of the respective material compositions in a subsequent learning phase, a currently acquired impedance spectrum of the test object is analyzed using the neural networks specific for the material composition in an analysis phase occurring thereafter that is crucial for the manufacturing process, and the material composition that best matches the respective neural network specific for the material composition for the impedance spectrum to be analyzed is output as a result, where a further improvement in the meaningfulness of the analysis is achieved by specifying the impedance spectrum as a complex-valued frequency curve, and by training separate neural networks specific to each of the material compositions for an absolute value, a phase angle, a real part and an imaginary part, which work in parallel in the analysis phase for the comparison with the currently acquired impedance spectrum in order to increase an accuracy of the statement about the material composition to be determined.

Within the meaning of the invention, neural networks, i.e. artificial neural networks, map neuron structures with learned knowledge. In the field of artificial intelligence there is a “knowledge discovery in database” method, often also referred to as data mining. From this data mining derives the general claim to discover unknown relationships from usually very large data sets. In this case, the algorithms used are operated differently, i.e. without specifying explicit expected results for analyzing the databases. Materials used in automated manufacturing are particularly subject to production- or batch-related fluctuations.

The invention offers the advantage of analyzing test objects, in which the relationship between object properties and impedance spectrum cannot be described analytically by physical laws.

In an embodiment of the method, a target material composition of the test object is stored in the allocation table and known deviations in the composition from the target material composition are selected for the further material compositions, where a current deviation of the material composition from the target material composition is ascertained aided by the target material composition based on the material compositions determined in the analysis phase.

The inventor has recognized that, in contrast to conventional methods of impedance spectroscopy, it is now possible, in combination with an evaluation device based on AI methods in conjunction with an automation device in manufacturing technology, to provide a material analysis, in particular for materials that cannot be described by physical or chemical forms. As a result, it becomes advantageously possible to assign particular impedance curves to specific properties of the test object in a training phase. In the ongoing manufacturing process, the properties can then be classified in real time. As a result of this classification, a KMO test and/or monitoring of the quality features of the test object is possible.

In conjunction with an automation device, it is then possible to control or regulate the process. For this purpose, the inventive method provides, in an embodiment for use in a manufacturing process of the test object, the ability to use the knowledge of the deviation of the material composition to intervene in the manufacturing process so that the test object again has the target material composition.

In a still further improved embodiment of the method, the detection phase is performed on a local automation component, and the training data sets specific for the material composition are sent to a higher-level computing system, where the learning phase is performed on the higher-level computing system, and the learned or calculated neural networks specific for the material composition are sent back from the higher-level computing system to the local automation component and are stored in the automation component for the analysis phase.

In accordance with the embodiments of the method, an automation device can then be structured modularly and can even be configured as a mobile structure. This mobile structure could then serve exclusively for teaching the AI applications. The data sets could then, for example, be fed into a cloud service and a trained neural network would be returned as a result. The trained neural network is then stored on the modular automation device and can then be integrated into the system located in the process. It is also conceivable for the neural network to be downloaded during operation of the system.

When evaluating the impedance spectrum in the form of a classification by neural networks, material compositions can be calculated in these individual forms of representation, i.e., absolute value, phase, real part and imaginary part, even in separate networks working in parallel. The properties of the substance to be examined can have different effects on the individual forms of representation (absolute value, phase, real part and imaginary part) and thus a more accurate hit rate for the classification in the neural networks is possible.

For an automation component comprising an impedance measuring unit configured to use an electric test signal to acquire an impedance spectrum dependent on a frequency and/or an amplitude of the test signal from a test object via a sensor, where a processor module is configured to process neural networks, and a data memory in which a neural network is stored, the objects and advantages are achieved in accordance with invention by providing an allocation table in which different material compositions are stored, and by providing a sample detection unit that is configured to acquire a predeterminable number of test spectra for the material compositions specified in the allocation table in a detection phase via the impedance measuring unit. Additionally, a data manager is provided, where the data manager is configured to store and manage the number of test spectra as training data sets specific for the material composition in the sample detection unit, an interface is designed to establish a connection to a learning tool, where the learning tool is configured to provide a neural network specific for each of the material compositions for the respective training data sets in a learning phase, the data memory is configured such that the specific neural networks are stored therein, where the processor module is configured to enable the currently acquired impedance spectrum to be analyzed with the specific neural networks in an analysis phase and as a result to output the material composition that for the impedance spectrum to be analyzed has proved to best match the respective neural network specific for the material composition.

The automation component is improved because a target material composition of the test object is stored in the allocation table and the further material compositions with known deviations in composition from the target material composition are stored, where a calculator is provided that is configured to ascertain the deviation of the material compositions based on the material composition determined in the analysis phase aided by the target material composition.

Owing to the training process, the specific properties of the test object are allocated to particular impedance curves in the subsequent learning phase. In an ongoing process, the properties can then be classified in real time. This classification makes it possible to control/monitor the quality features of the test object. In conjunction with an automation device, it is still possible to control or regulate the manufacturing process.

To this end, the automation component is structured for use in a manufacturing process of the test object with a reporting unit, which in turn is configured to notify the deviation of the material composition to a regulation and/or control unit, which in turn is configured to intervene in the manufacturing process so that the test object to be manufactured again has the target material composition.

In order to outsource the training data sets or, for example, to enable them to be processed in a cloud service, the automation component is structured with a data transfer unit, which is configured to send the training data sets specific for the material composition to a higher-level computing system using the data manager.

Owing to a modular structure of an automation device, it would be possible to create a mobile structure, in particular with the automation component. The mobile structure could then be exclusively entrusted with training an AI application. The trained neural network can then subsequently be saved back to the automation component.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The drawing shows an exemplary embodiment of the invention, in which:

FIG. 1 shows a schematic block diagram of an automation component for analyzing a material composition in accordance with the invention;

FIG. 2 shows the method sequence in a symbolic representation of different phases in accordance with the invention;

FIG. 3 shows a clarification of the determination of test spectra using previously specially prepared test samples; and

FIG. 4 is a flowchart of the method in accordance with the invention.

### DETAILED DESCRIPTION OF THE EXEMPLARY EMBODIMENTS

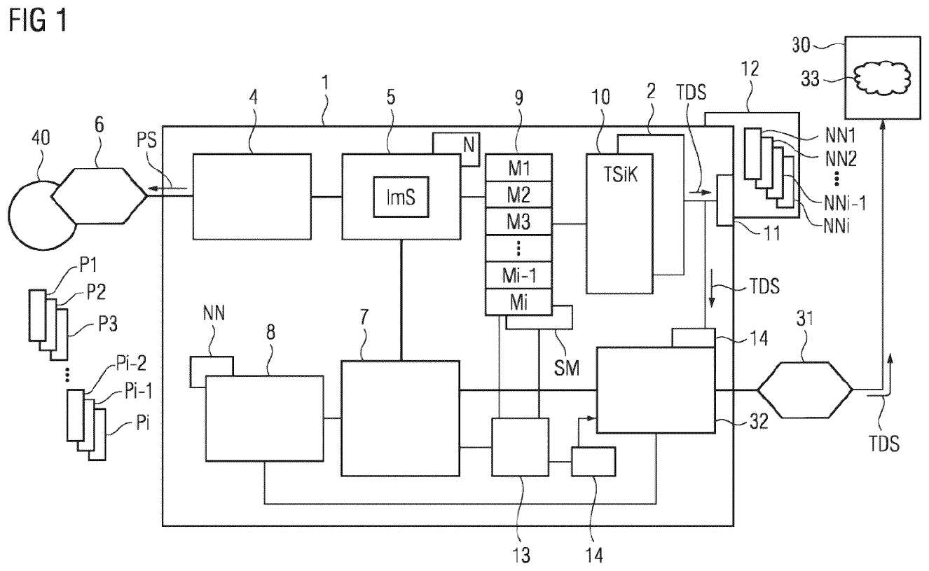

FIG. 1 shows an automation component 1, which is configured to analyze the material composition Mi of a test object 40. The test object 40 is analyzed via a sensor 6 via a test signal PS. An impedance measuring unit 5 is configured to use the electric test signal PS to acquire an impedance spectrum ImS dependent on a frequency and/or an amplitude of the test signal PS from the test object 40 via the sensor 6. A sensor-specific sensor interface 4 is arranged between the sensor 6 and the impedance measuring unit 5.

The automation component 1 has a processor module 7 for evaluating a neural network NN. The processor module 7 is coupled to a data memory 8 in which the neural network or neural networks NNi are stored.

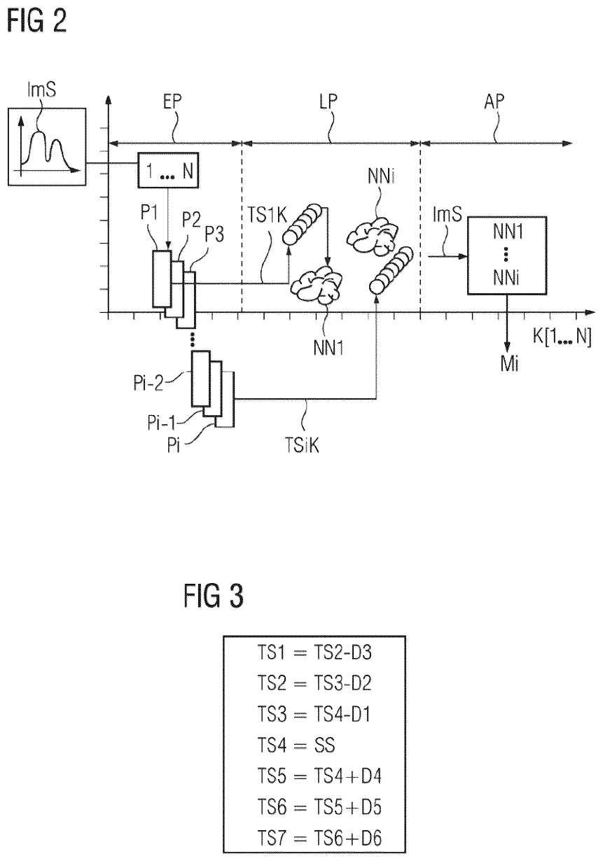

For a detection phase EP (see FIG. 2), a test sample Pi is employed for the test object i,O in each case and a predeterminable number N=100 of test spectra TSi1, . . . , 100 is acquired from the respective test sample Pi via the impedance measuring unit 5. This number N=100 of test spectra is stored as a training data set TDs specific to the material composition Mi in a sample detection unit 10.

This means that in a first detection phase EP a first test sample P1, which corresponds to a first material composition Mi, is provided for the measurement of test spectra corresponding to precisely this material composition. Accordingly, as many material compositions Mi are stored in the allocation table 9 as there are test samples Pi.

For a learning phase LP, the test spectra TSi1, . . . , 100 of the respective material composition Mi are trained to form a neural network NNi specific to the material composition Mi. To this end, the training data sets TDs can either be passed on to a learning tool 12 via an interface 11 or forwarded to a bus system 31 via a bus interface 32 so that the training data sets TDs can be forwarded to a higher-level computing system 30. In this higher-level computing system 30, there is a learning algorithm 33 in which the training data sets TDs are trained into neural networks NNi specific to the material composition Mi.

A target material composition SM of the test object 40 is further stored in the allocation table 9. A known deviation in composition from the target material composition SM is likewise stored for the further material compositions Mi. A calculator 13 is available which is configured to ascertain the deviation of the material composition SM based on the test spectra for the material composition determined in the analysis phase AP aided by the target material composition SM.

Furthermore, a reporting unit 14 exists in the automation component, which is configured to notify the deviation of the material composition to a regulation and/or control unit, which then in turn is configured to intervene in the manufacturing process so that the test object 40 to be remanufactured has the target material composition.

In accordance with FIG. 2, the detection phase EP, the learning phase LP and the analysis phase AP of the method for analyzing a material composition Mi of a test object are essentially represented. In each case, a test sample P1, P12, P3, . . . , Pi-2, Pi-1, Pi is provided in the detection phase EP for the test object 40. The impedance measuring unit 5 is used to acquire a number N of impedance spectra ImS for each test sample Pi. The acquired impedance spectra ImS are then allocated to the test samples Pi or the material composition Mi and yield the acquired test spectra TSik from the respective test sample Pi.

In a learning phase LP, a neural network NNi specific to the material composition Mi is trained for the number N of test spectra TSik of the respective material composition Mi. Accordingly, a first neural network NN1 specific for the material composition Mi is formed from a first test spectrum TSik for a first test sample P1, and likewise an i-th test spectrum TSik is combined for an i-th test sample Pi for an I-th material composition Mi, and an i-th neural network NNi specific for the material composition Mi is trained or generated or formed.

In the subsequent analysis phase AP, a currently acquired impedance spectrum ImS of the test object 40 is in turn analyzed with the neural networks NNi specific for the material composition Mi and as a result the material composition Mi is output that has proved to best match the respective neural network NNi specific for the material composition Mi for the impedance spectrum ImS to be analyzed.

FIG. 3 once again represents the relationship between the known deviations of the test samples Pi in material composition and the composition of the target material composition SM. Using a fourth test sample, a test spectrum TS4 is acquired that corresponds to the target spectrum SS. Using a third test sample P3, a third test spectrum TS3 is then acquired that corresponds to the material composition SM of the fourth test sample P4 minus a deviation D1. Using a fifth test sample P5, a test spectrum TS is acquired that corresponds to a material deviation of the fourth test sample P4 plus a deviation D4, etc.

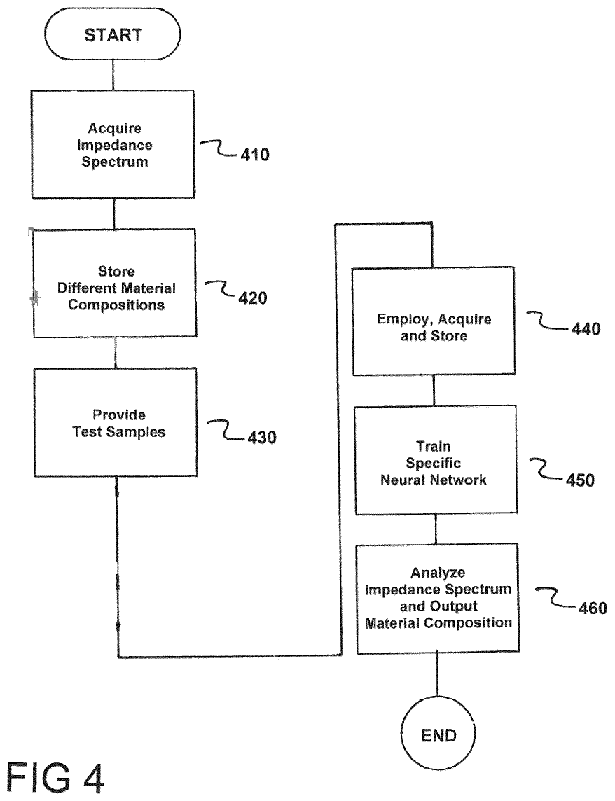

FIG. 4 is a flowchart of the method for analyzing the material composition of a test object 40. The method comprises acquiring, by an impedance measuring unit 5 via an electric test signal PS, an impedance spectrum ImS dependent on at least one of a frequency f and an amplitude of the test signal PS from the test object 40 via a sensor 6, as indicated in step 410.

Next, different material compositions Mi are stored in an allocation table 9, as indicated in step 420.

Next, a test sample Pi is provided for each of the material compositions Mi, as indicated in step 430.

Next, a respective test sample Pi for the test object 40 is employed in a detection phase EP, a specifiable number N of test spectra TSik is acquired from the respective test sample Pi via the impedance measuring unit 5, and the number of test spectra TSik are stored in a sample detection unit 10 as a training data set specific to the material composition Mi, as indicated in step 440.

Next, a specific neural network NNi for the number N of test spectra TSik of the respective material compositions Mi is trained during a learning phase, as indicated in step 450.

Next, a currently acquired impedance spectrum ImS of the test object 40 is analyzed utilizing the neural networks specific to the material composition Mi during an analysis phase AP, and the material composition Mi that has proved to best match the respective neural network NNi specific for the material composition Mi for the impedance spectrum ImS to be analyzed is output as a result, as indicated in step 460.

In accordance with the inventive method, the impedance spectrum ImS is specified as a complex-valued frequency curve, and separate neural networks NNi specific for the material composition Mi are trained for an absolute value, a phase angle, a real part and an imaginary part in each case, which operate in parallel in the analysis phase AP for the comparison with the currently acquired impedance spectrum ImS to increase an accuracy of a statement about the material composition to be determined.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-8. (canceled)

9. A method for analyzing material composition of a test object, the method comprising:
acquiring, by an impedance measuring unit via an electric test signal, an impedance spectrum dependent on at least one of a frequency and an amplitude of the test signal from the test object via a sensor;
storing different material compositions in an allocation table;
providing a test sample for each of the material compositions;
employing a respective test sample for the test object in a detection phase, acquiring a specifiable number of test spectra from the respective test sample via the impedance measuring unit, and storing said number of test spectra in a sample detection unit as a training data set specific to the material composition;
training a specific neural network for the number of test spectra of the respective material compositions during a learning phase; and
analyzing a currently acquired impedance spectrum of the test object utilizing the neural networks specific to the material composition in an analysis phase, and outputting the material composition which has proved to best match the respective neural network specific for the material composition for the impedance spectrum to be analyzed as a result;
wherein the impedance spectrum is specified as a complex-valued frequency curve, and separate neural networks specific for the material composition are trained for an absolute value, a phase angle, a real part and an imaginary part in each case, which operate in parallel in the analysis phase for the comparison with the currently acquired impedance spectrum to increase an accuracy of a statement about the material composition to be determined.

10. The method as claimed in claim 9, wherein a target material composition of the test object is stored in the allocation table and known deviations in composition from the target material composition are selected for the further material compositions; wherein a current deviation of the material composition is ascertained added by the target material composition based on the material composition determined in the analysis phase.

11. The method as claimed in claim 9, wherein the method is implemented in a manufacturing process of the test object; and wherein the knowledge of the deviation of the material composition is utilized to intervene in the manufacturing process so that the test object to be remanufactured has the target material composition.

12. The method as claimed in claim 10, wherein the method is implemented in a manufacturing process of the test object; and wherein the knowledge of the deviation of the material composition is utilized to intervene in the manufacturing process so that the test object to be remanufactured has the target material composition.

13. The method as claimed in claim 9, wherein the detection phase is performed on a local automation component, and the training data sets specific to the material composition are sent to a higher-level computing system; and wherein the learning phase is performed on the higher-level computing system, and the learned or calculated neural networks specific to the material composition are sent back from the higher-level computing system to the local automation component and are stored for the analysis phase.

14. The method as claimed in claim 10, wherein the detection phase is performed on a local automation component, and the training data sets specific to the material composition are sent to a higher-level computing system; and wherein the learning phase is performed on the higher-level computing system, and the learned or calculated neural networks specific to the material composition are sent back from the higher-level computing system to the local automation component and are stored for the analysis phase.

15. The method as claimed in claim 11, wherein the detection phase is performed on a local automation component, and the training data sets specific to the material composition are sent to a higher-level computing system; and wherein the learning phase is performed on the higher-level computing system, and the learned or calculated neural networks specific to the material composition are sent back from the higher-level computing system to the local automation component and are stored for the analysis phase.

16. An automation component comprising:
an impedance measuring unit configured to utilize an electric test signal to acquire an impedance spectrum dependent on at least one of a frequency and an amplitude of the test signal from a test object via a sensor;
a processor module configured to process neural networks;
a data memory in which a neural network is stored;
an allocation table in which different material compositions are stored;
a sample detection unit configured to acquire a specifiable number of test spectra for the material compositions specified in the allocation table in a detection phase via the impedance measuring unit;
a data manager configured to store and manage the specifiable number of test spectra as training data sets specific to the material composition in the sample detection unit;
an interface to a learning tool, which is configured in each case to provide a neural network specific to the material composition in a learning phase for respective training data sets;
wherein the data memory stores specific neural networks are stored; and
wherein the processor module enables a currently acquired impedance spectrum to be analyzed with the specific neural networks in an analysis phase such that the material composition to be output which, for the impedance spectrum to be analyzed has proved to best match the respective neural network specific to the material composition.

17. The automation component as claimed in claim 16, wherein a target material composition of the test object is stored in the allocation table and the further material compositions with known deviations in composition from the target material composition are stored; and wherein a calculator is provided which is designed to ascertain the deviation of the material composition based on the material composition determined in the analysis phase aided by the target material composition.

18. The automation component as claimed in claim 17, wherein the automation component is configured for use in a manufacturing process of the test object comprising a reporting unit configured to notify the deviation of the material composition to a regulation and/or control unit configured to intervene in the manufacturing process such that the test object to be remanufactured has the target material composition.

19. The automation component as claimed in claim 16, further comprising:
a data transfer unit configured to utilize the data manager to send the training data sets specific to the material composition to a higher-level computing system.

20. The automation component as claimed in claim 17, further comprising:
a data transfer unit configured to utilize the data manager to send the training data sets specific to the material composition to a higher-level computing system.

21. The automation component as claimed in claim 18, further comprising:
a data transfer unit configured to utilize the data manager to send the training data sets specific to the material composition to a higher-level computing system.
